(19) United States
(12) Patent Application Publication
(10) Pub. No.: US 2014/0320717 A1
(43) Pub. Date: Oct. 30, 2014

(54) PHOTOELECTRIC CONVERSION APPARATUS AND IMAGING SYSTEM

(71) Applicant: CANON KABUSHIKI KAISHA, Tokyo (JP)

(72) Inventors: Hiroki Hiyama, Sagamihara-shi (JP); Yasuji Ikeda, Kawasaki-shi (JP)

(73) Assignee: CANON KABUSHIKI KAISHA, Tokyo (JP)

(21) Appl. No.: 14/245,313

(22) Filed: Apr. 4, 2014

(30) Foreign Application Priority Data
Apr. 25, 2013 (JP) 2013-092459

(51) Int. Cl. H04N 5/374

(52) U.S. Cl. CPC H04N 5/374
USPC 348/308

(57) ABSTRACT

The present disclosure relate to photoelectric conversion apparatus and imaging system. The photoelectric conversion apparatus has a plurality of pixels arranged in rows and columns, and each configured to generate a signal by photoelectric conversion, a plurality of holding capacitors arranged correspondingly to the respective columns of the plurality of pixels, and configured to hold signals based on the pixels, a first output line, a second output line, a first switch arranged between the holding capacitor and the first output line, a second switch arranged between the holding capacitor and the second output line, and a column selecting line configured to control the second switch, wherein a wiring structure of a portion at which the column selecting line intersects the first output line is different from a wiring structure of a portion at which the column selecting line intersects the second output line.

### BACKGROUND OF THE INVENTION

1. Field of the Invention

The present invention relates to a photoelectric conversion apparatus and an imaging system for use in a scanner, a video camera, a digital still camera and the like.

2. Description of the Related Art

Japanese Patent Application Laid-Open No. 2003-259227 discloses a technique of reading signals from a column memory by two horizontal scanning circuits that operate in different phases, multiplexing the outputs from two horizontal output lines, and outputting the multiplexed outputs, in a CMOS image sensor. By doing so, a signal can be output from the CMOS image sensor at a frequency higher than the drive frequency of the horizontal output lines, and a photoelectric conversion apparatus with a high frame rate can be realized.

However, the CMOS image sensor as in Japanese Patent Application Laid-Open No. 2003-259227 has the following problem. In order to read a signal to the two horizontal output lines from the column memory in different phases as described above, the first column selecting line that provides electrical continuity between the column memory and the first horizontal output line in one phase, and the second column selecting line that sequentially provides electrical continuity between the column memory and the second horizontal output line in the other phase are included. There arises a problem that the first column selecting line capacitively couples with the second horizontal output line, or the second column selecting line capacitively couples with the first horizontal output line resulting in a superimpose of noise in the signal reading time period.

### SUMMARY OF THE INVENTION

According to an aspect of the present invention, a photoelectric conversion apparatus comprises: a plurality of pixels arranged in rows and columns, and each configured to generate a signal by photoelectric conversion; a plurality of holding capacitors each arranged correspondingly to one of the columns of the plurality of pixels, and configured to hold a signal based on the signal generated by the pixel; a first output line; a second output line; a first switch arranged between the holding capacitor and the first output line; a second switch arranged between the holding capacitor and the second output line; and a column selecting line configured to control the second switch, wherein a wiring structure of a portion at which the column selecting line intersects with the first output line is different from a wiring structure of a portion at which the column selecting line intersects with the second output line.

Further features of the present invention will become apparent from the following description of exemplary embodiments with reference to the attached drawings.

### BRIEF DESCRIPTION OF THE DRAWINGS

FIG. 1 is a diagram illustrating a photoelectric conversion apparatus of a first embodiment of the present invention.

FIG. 2 is a circuit diagram of a pixel of the first embodiment of the present invention.

FIG. 3 is a circuit diagram of an amplifier circuit of the first embodiment of the present invention.

FIG. 4 is a diagram of timing of driving the first embodiment of the present invention.

FIG. 5 is a plan view of a part of the first embodiment of the present invention.

FIG. 6 is a sectional view of a part of the first embodiment of the present invention.

FIG. 7 is a sectional view of a part of the first embodiment of the present invention.

FIG. 8 is a sectional view of a part of the first embodiment of the present invention.

FIG. 9 is a plan view of a part of a second embodiment of the present invention.

FIG. 10 is a sectional view of a part of the second embodiment of the present invention.

FIG. 11 is a sectional view of a part of the second embodiment of the present invention.

FIG. 12 is a sectional view of a part of the second embodiment of the present invention.

FIG. 13 is a diagram illustrating a configuration example of an imaging system.

### DESCRIPTION OF THE EMBODIMENTS

Preferred embodiments of the present invention will now be described in detail in accordance with the accompanying drawings.

### First Embodiment

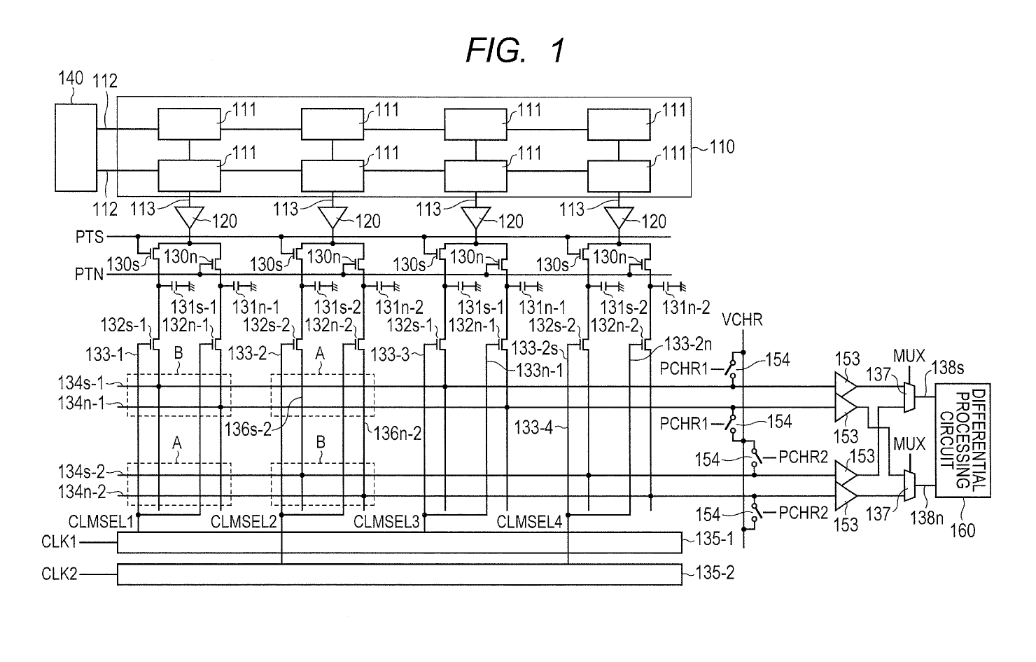

FIG. 1 is a diagram illustrating a configuration example of a photoelectric conversion apparatus according to a first embodiment of the present invention. The photoelectric conversion apparatus is a CMOS image sensor, for example, and photoelectrically converts incident light of an object image, amplifies an electric signal obtained by photoelectric conversion and outputs the electric signal to an outside. The photoelectric conversion apparatus has a pixel array 110. The pixel array 110 has a plurality of pixels 111 that are arranged in two dimensional rows and columns. FIG. 1 illustrates eight of the pixels 111 for simplification, but the number of pixels 111 is not limited to eight, and a larger number of pixels 111 may be included. The respective pixels 111 generate signals by photoelectric conversion.

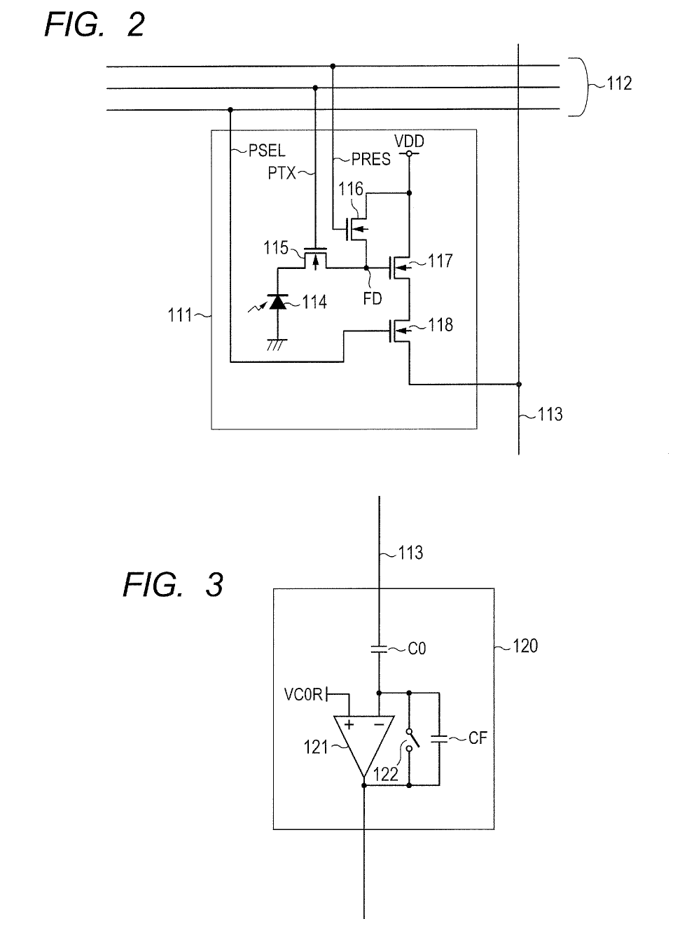

FIG. 2 is a circuit diagram illustrating a configuration example of the pixel 111. A pixel control signal line 112 has a row selecting pulse line PSEL, a pixel transfer pulse line PTX and a pixel reset pulse line PRES. A photoelectric conversion section 114 is a photodiode, for example, and converts light into electric charges to accumulate the electric charges. A pixel transfer switch 115 transfers the electric charges that are accumulated in the photoelectric conversion section 114 to a floating diffusion FD in response to a voltage of the pixel transfer pulse line PTX. The floating diffusion FD accumulates electric charges, and converts the electric charges into voltage. A pixel reset switch 116 resets the voltage of the floating diffusion FD and/or the photoelectric conversion section 114 to power supply voltage VDD in response to voltage of the pixel reset pulse line PRES. A pixel amplifier transistor 117 amplifies the voltage of the floating diffusion FD. A row selecting switch 118 outputs the voltage that is amplified by the pixel amplifier transistor 117 to a column signal line 113 in response to voltage of the row selecting pulse line PSEL. The column signal line 113 is provided for each of columns of the pixels 111 arranged in rows and columns. The pixels 111 in each of the columns are connected to each of the column signal lines 113.

The photoelectric conversion apparatus of FIG. 1 further has a vertical scanning circuit 140. The vertical scanning circuit 140 is connected to the respective rows of the pixels 111 via the pixel control signal lines 112. The pixels 111 in each of the rows are connected to the same pixel control signal line 112. The pixel 111 outputs voltage to the column signal line 113 as described above. The amplifier circuit 120 amplifies the voltage of the column signal line 113.

FIG. 3 is a circuit diagram illustrating a configuration example of the amplifier circuit 120. The amplifier circuit 120 has an operational amplifier 121, a reset switch 122, an input capacitor C0 and a feedback capacitor CF, and invertingly amplifies the voltage of the column signal line 113. When the reset switch 122 is turned on, the amplifier circuit 120 is reset, whereas when the reset switch 122 is turned off, the reset of the amplifier circuit 120 is cancelled.

In FIG. 1, holding capacitors 131s-1 and 131n-1 in odd-numbered columns, and holding capacitors 131s-2 and 131n-2 in even-numbered columns are provided in the respective columns of the plurality of pixels 111, and hold signals based on the pixels 111.

When the pixels 111 and the amplifier circuits 120 are reset, the amplifier circuits 120 output noise signals, and transfer switches 130n are turned on by a control signal PTN. The noise signals are held in the holding capacitors 131n-1 and 131n-2 via the transfer switches 130n. The first holding capacitors 131n-1 and 131n-2 hold the signals of a reset state of the pixels 111.

When reset of the pixels 111 is cancelled, the photoelectric conversion section 114 starts photoelectric conversion and accumulation of electric charges. When reset of the amplifier circuit 120 is cancelled, and the pixel transfer switch 115 is turned on, the pixel 111 outputs a pixel signal in which a signal corresponding to the electric charge generated by photoelectric conversion is superimposed on the noise signal to the column signal line 113 by the row selecting switch 118 being turned on. The amplifier circuit 120 amplifies the pixel signal of the column signal line 113 to output the pixel signal. When transfer switches 130s are turned on by a control signal PTS, the pixel signals are held in the holding capacitors 131s-1 and 131s-2 via the transfer switches 130s. The second holding capacitors 131s-1 and 131s-2 hold the signals in a non-reset state of the pixels 111.

A first column selecting switch 132n-1 is arranged between the holding capacitor 131n-1 and a first horizontal output line 134n-1. A first column selecting switch 132s-1 is arranged between the holding capacitor 131s-1 and a first horizontal output line 134s-1. A second column selecting switch 132n-2 is arranged between the holding capacitor 131n-2 and a second horizontal output line 134n-2. A second column selecting switch 132s-2 is arranged between the holding capacitor 131s-2 and a second horizontal output line 134s-2.

When the first column selecting switch 132n-1 is turned on, the voltage that is held by the holding capacitor 131n-1 is read to the horizontal output line 134n-1. Further, when the first column selecting switch 132s-1 is turned on, the voltage that is held by the holding capacitor 131s-1 is read to the horizontal output line 134s-1. Further, when the second column selecting switch 132n-2 is turned on, the voltage that is held by the holding capacitor 131n-2 is read to the horizontal output line 134n-2. Further, when the second column selecting switch 132s-2 is turned on, the voltage that is held by the holding capacitor 131s-2 is read to the horizontal output line 134s-2. Electric charges are distributed according to capacitance ratios of capacitance values of the holding capacitors 131n-1, 131s-1, 131n-2 and 131s-2, and capacitance including wiring capacitance values of the horizontal output lines 134n-1, 134s-1, 134n-2 and 134s-2, and junction capacitance of switches that are connected to wiring. The above described reading is based on the reading method by distribution of the electric charges described above. That is, the horizontal output lines 134n-1, 134s-1, 134n-2 and 134s-2 during the reading time period are in a high-impedance state.

Pixel signals of the horizontal output lines 134s-1 and 134s-2 are subjected to impedance conversion by a buffer 153, and are output to an output terminal 138s via a multiplexer 137. Noise signals of the horizontal output lines 134n-1 and 134n-2 are subjected to impedance conversion by the buffer 153, and are output to an output terminal 138n via the multiplexer 137.

The horizontal output lines 134n-1, 134s-1, 134n-2 and 134s-2 hold signals for a predetermined time period, and thereafter are reset to voltage VCHR by switches 154. A horizontal scanning circuit (controlling unit) 135-1 is synchronized with a clock signal CLK1 of a first phase, and controls the column selecting switches 132n-1 and 132s-1. A horizontal scanning circuit (controlling unit) 135-2 is synchronized with a clock signal CLK2 of a second phase that is different from the first phase, and controls the column selecting switches 132n-2 and 132s-2. A multiplexer 137 multiplexes the signals of different phases that are input from the first horizontal output lines 134n-1 and 134s-1 and the second horizontal output lines 134n-2 and 134s-2 according to a control signal MUX, and outputs the multiplexed signals to the output terminals 138n and 138s. A differential processing circuit 160 performs differential processing of the pixel signal of the output terminal 138s and the noise signal of the output terminal 138n, and outputs a pixel signal from which noise is removed.

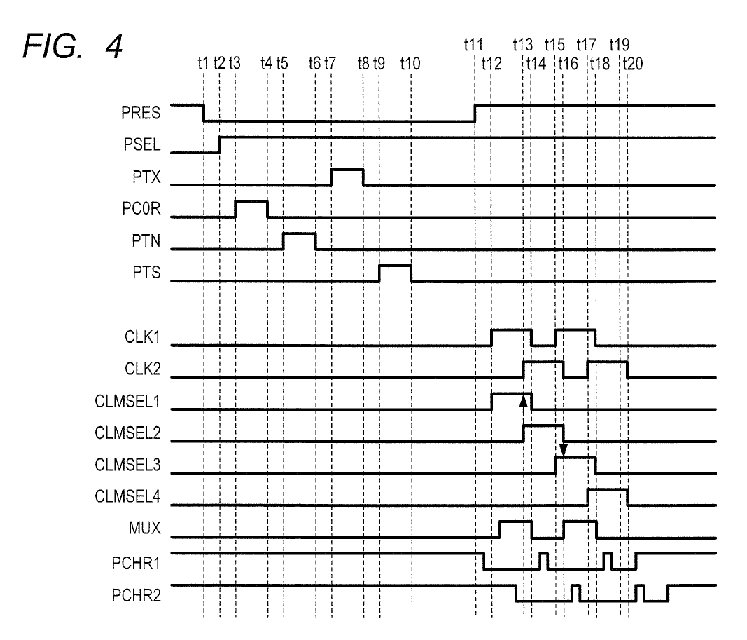

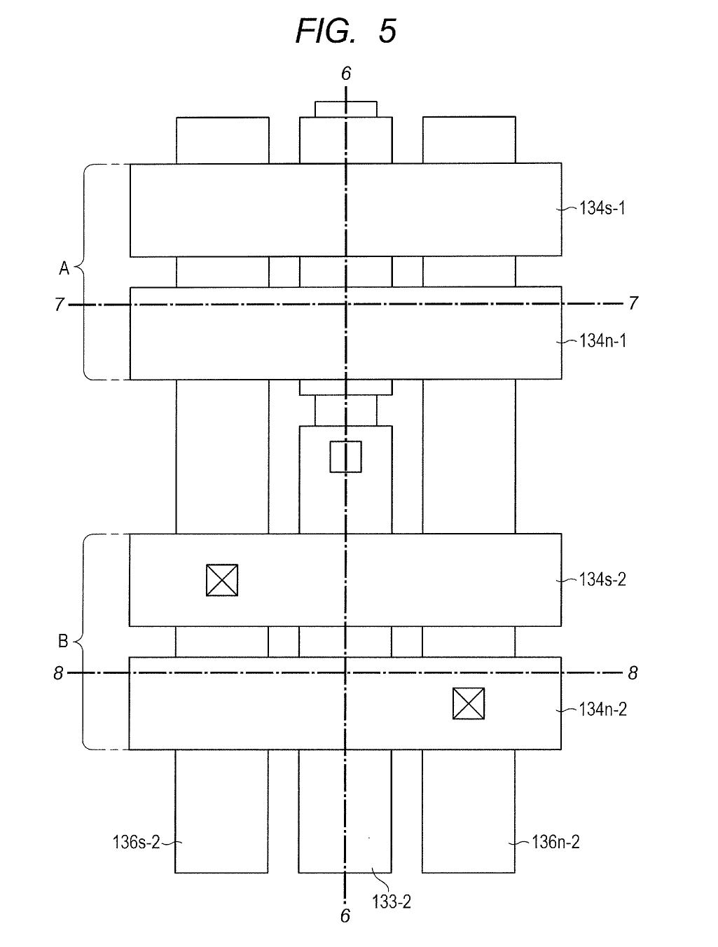

FIG. 4 is a timing chart illustrating a drive method of the photoelectric conversion apparatus of the present embodiment. PRES represents voltage of the pixel reset pulse line. PSEL represents voltage of the row selecting pulse line. PTX represents voltage of the pixel transfer pulse line. Further, PC0R represents a reset signal that controls the reset switch 122 in the amplifier circuit 120. Further, PTN represents a sample hold signal that controls the transfer switch 130n. PTS represents a sample hold signal that controls the transfer switch 130s. Further, CLMSEL1 and CLMSEL3 represent column selecting pulses that control the column selecting switches 132s-1 and 132n-1, and are respectively supplied to column selecting lines 133-1 and 133-3. CLMSEL2 and CLMSEL4 are column selecting pulses that control the column selecting switches 132s-2 and 132n-2, and are respectively supplied to column selecting lines 133-2 and 133-4. A first column selecting line 133-1 is the line for controlling the column selecting switches 132s-1 and 132n-1 in a first column. A second column selecting line 133-2 is a line for controlling the column selecting switches 132s-2 and 132n-2 in a second column. A third column selecting line 133-3 is a line for controlling the column selecting switches 132s-1 and 132n-1 in a third column. A fourth column selecting line 133-4 is a line for controlling the column selecting switches 132s-2 and 132n-2 in a fourth column.

Before a time t1, the pixel reset pulse line PRES rise to a high level, the pixel reset switch 116 is turned on, and the floating diffusion FD is reset to the power supply voltage VDD.

From the time t1 to a time t11, the pixel reset pulse line PRES changes to a low level, and the pixel reset switch 116 is turned off. Further, at and after a time t2, the row selecting pulse line PSEL rises to a high level, and the row selecting switch 118 is turned on, whereby the signals of the pixels 111 in a predetermined row can be read. At a time t3, the reset signal PC0R changes to a high level, the reset switch 122 is turned on, and the amplifier circuit 120 is reset. At a time t4, the reset signal PC0R changes to a low level, the reset switch 122 is turned off, and the reset of the amplifier circuit 120 is cancelled. The pixel 111 outputs a noise signal to the column signal line 113 by reset of the floating diffusion FD. The amplifier circuit 120 amplifies a noise signal and outputs the noise signal. From a time t5 to a time t6, the sample hold signal PTN rises to a high level, and the sample hold switch 130n is turned on. The noise signals that are output by the respective amplifier circuits 120 are held in the holding capacitors 131n-1 and 131n-2 in the respective columns via the sample hold switches 130n.

From a time t7 to a time t8, the pixel transfer pulse line PTX rises to a high level, and the pixel transfer switch 115 is turned on. Thereupon, the electric charges that are photoelectrically converted by the photoelectric conversion section 114 in the pixel 111 are transferred to the floating diffusion FD via the pixel transfer switch 115. The pixel 111 outputs the pixel signal in which the signal photoelectrically converted is superimposed on the noise signal described above to the column signal line 113. The amplifier circuit 120 amplifies the pixel signal of the column signal line 113 and outputs the pixel signal.

From a time t9 to a time t10, the sample hold signal PTS rises to a high level, and the sample hold switch 130s is turned on. The pixel signals that are output by the respective amplifier circuits 120 are held in the holding capacitors 131s-1 and 131s-2 in the respective columns via the sample hold switches 130s.

At and after a time t11, the pixel reset pulse line PRES rises to a high level, the pixel reset switch 116 is turned on, and the floating diffusion FD is reset to the power supply voltage VDD.

At and after a time t12, the clock signal CLK1 of the first phase and the clock signal CLK2 of the second phase are respectively supplied to the horizontal scanning circuits 135-1 and 135-2. The horizontal scanning circuit 135-1 generates column selecting pulses CLMSEL1 and CLMSEL3 based on the clock signal CLK1 of the first phase. First, when the column selecting pulse CLMSEL1 rises to a high level synchronously with the clock signal CLK1 of the first phase, the column selecting switches 132s-1 and 132n-1 are turned on. Thereby, the pixel signal and the noise signal that are held in the holding capacitors 131s-1 and 131n-1 are read to the first horizontal output lines 134s-1 and 134n-1. Next, the column selecting pulse CLMSEL3 rises to a high level synchronously with the clock signal CLK1 of the first phase, and the pixel signal and the noise signal of the third column are read in the same manner as described above.

Likewise, the horizontal scanning circuit 135-2 generates column selecting pulses CLMSEL2 and CLMSEL4 based on the clock signal CLK2 of the second phase. First, when the column selecting pulse CLMSEL2 rises to a high level synchronously with the clock signal CLK2 of the second phase, the column selecting switches 132s-2 and 132n-2 are turned on. Thereby, the pixel signal and the noise signal that are held in the holding capacitors 131s-2 and 131n-2 are read to the second horizontal output lines 134s-2 and 134n-2. Next, the column selecting pulse CLMSEL4 rises to a high level synchronously with the clock signal CLK2 of the second phase, and the pixel signal and the noise signal of the fourth column are read in the same manner as described above.

Based on the multiplex signal MUX, in the multiplexers 137, any one of the outputs of the first horizontal output lines 134s-1 and 134n-1, and the outputs of the second horizontal output lines 134s-2 and 134n-2 are selected, and are respectively read to the output terminals 138s and 138n.

When a signal PCHR1 rises to a high level, the switch 154 is turned on, and the horizontal output lines 134s-1 and 134n-1 are reset to the voltage VCHR. Further, when a signal PCHR2 rises to a high level, the switch 154 is turned on, and the horizontal output lines 134s-2 and 134n-2 are reset to the voltage VCHR.

The arrows in FIG. 4 indicate rising and falling of the signal CLMSEL2. By a potential change of the column selecting line 133-2 at a rising time of the signal CLMSEL2, noise is laid on the signals that are being read to the horizontal output lines 134s-1 and 134n-1 from the holding capacitors 131s-1 and 131n-2 in the first column by the signal CLMSEL1. Further, by a potential change of the column selecting line 133-2 at a falling time of the signal CLMSEL2, noise is laid on the signals that are being read to the horizontal output lines 134s-1 and 134n-1 from the holding capacitors 131s-1 and 131n-2 in the third column by the signal CLMSEL3. The noise countermeasures will be described later with reference to FIGS. 5 to 8.

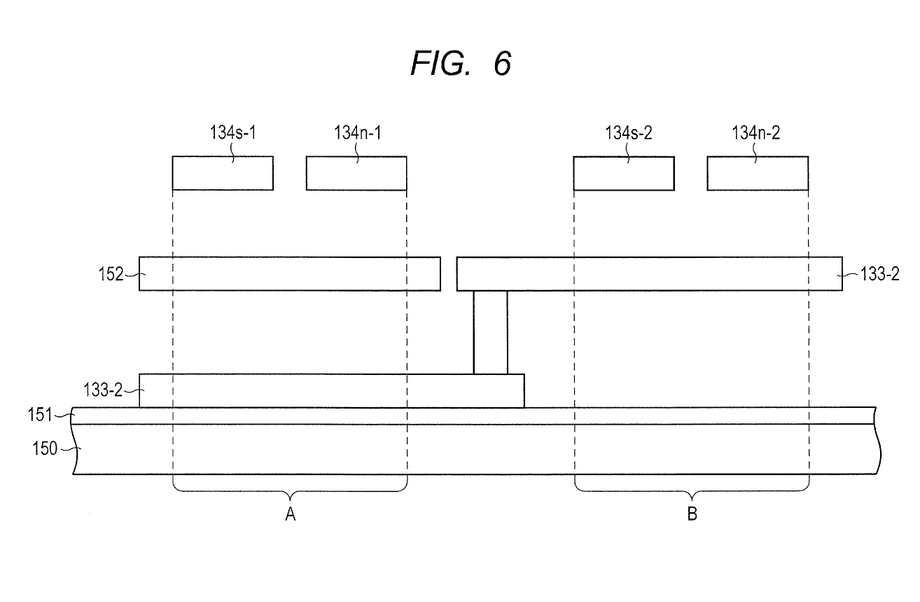

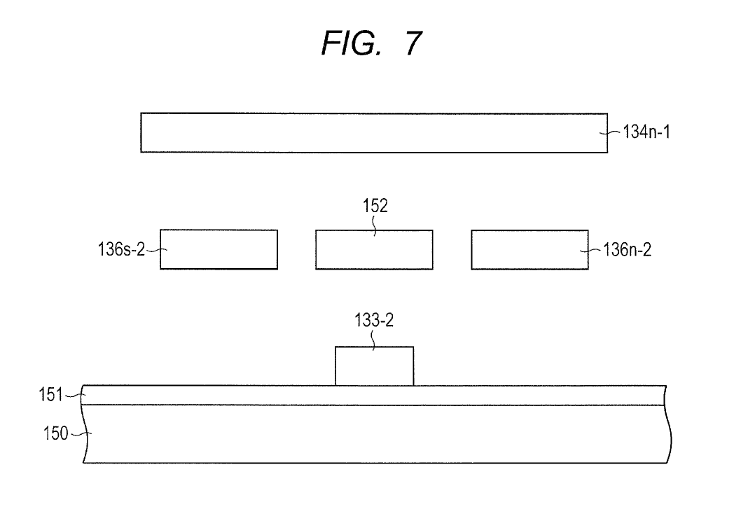

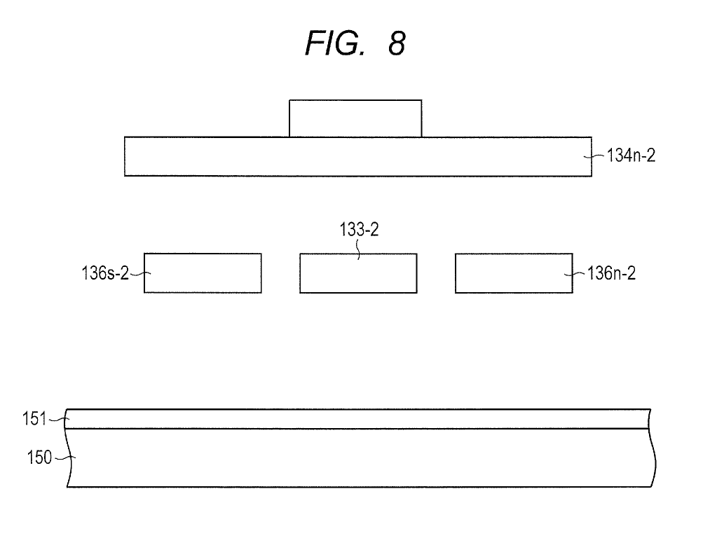

FIG. 5 is a plan view of an intersection portion of the column selecting line 133-2 and the horizontal output lines 134s-1, 134n-1, 134s-2 and 134n-2 in the photoelectric conversion apparatus of FIG. 1. FIG. 6 is a sectional view taken along the line 6-6 in FIG. 5. FIG. 7 is a sectional view taken along the line 7-7 in FIG. 5. FIG. 8 is a sectional view taken along the line 8-8 in FIG. 5.

A polysilicon layer, a first aluminum layer and a second aluminum layer are stacked on a silicon substrate 150 and an element isolation oxide film 151, and the polysilicon layer and the first aluminum layer are connected by a contact hole. With respect to the horizontal output lines 134s-2 and 134n-2 that are formed of the second aluminum layer, the column selecting line 133-2 is formed of the first aluminum layer directly below, and forms wiring with low resistance, in a region B. Attention is paid to the fact that even if the column selecting line 133-2 is capacitively coupled with the horizontal output lines 134s-2 and 134n-2 to a certain degree, the potentials of the horizontal output lines 134s-2 and 134n-2 change synchronously with the potential change of the column selecting line 133-2, but an influence on the sampling time period is small. In a region A, the column selecting line 133-2 is formed of the polysilicon layer to avoid capacitive coupling with the horizontal output lines 134s-1 and 134n-1 that are driven in a different phase. The column selecting line 133-2 is formed of the first aluminum layer in the region B, is formed of the polysilicon layer in the region A, and is formed in different wiring layers in the region A and the region B.

Further, in order to reduce capacitive coupling of the column selecting line 133-2 and the horizontal output lines 134s-1 and 134n-1, a shield 152 is arranged between the column selecting line 133-2 and the horizontal output lines 134s-1 and 134n-1. This is because the potential change of the column selecting line 133-2 coincides with a latter half of a time period in which the horizontal output lines 134s-1 and 134n-1 output signals, and is close to a time when an external circuit performs sampling. In the region A, the shield 152 is arranged between the column selecting line 133-2 and the horizontal output lines 134s-1 and 134n-1, whereas in the region B, the shield 152 is not arranged between the column selecting line 133-2 and the horizontal output lines 134s-2 and 134n-2.

By making the structure of the column selecting line 133-2 different in the region A and the region B as above, noise is difficult to superimpose on the horizontal output lines 134s-1 and 134n-1 that are driven in a different phase. Further, in the present embodiment, the column selecting line 133-2 is reduced in wiring resistance by using aluminum wiring with low resistance in the region B, and thereby, even if the column selecting line 133-2 is capacitively coupled to the horizontal output lines 134s-2 and 134n-2 that are driven in the same phase, an influence thereon can be decreased.

Further, as shown in FIG. 8, wirings 136s-2 and 136n-2 that are led from the holding capacitors 131s-2 and 131n-2 to the horizontal output lines 134s-2 and 134n-2 are formed of the same layer as the column selecting line 133-2. Thereby, a capacitive coupling amount between the column selecting line 133-2 and the wiring 136s-2, and a capacitive coupling amount between the column selecting line 133-2 and the wiring 136n-2 can be made unaffected by an alignment error between different wiring layers, and can be uniformized with high precision. Consequently, an offset error caused by an imbalance of the capacitive coupling of the column selecting line 133-2 to the wirings 136s-2 and 136n-2 can be reduced.

In the above, explanation is made with attention paid to the circuit in the second column from the left in FIG. 1. In contrast with this, in the first column from the left, the positions of the aforementioned region A and region B become inverted. More specifically, a region where the column selecting line 133-1 intersects the horizontal output lines 134s-1 and 134n-1 has the same structure as that of the region B illustrated in FIGS. 5 to 8, and a region where the column selecting line 133-1 intersects the horizontal output lines 134s-2 and 134n-2 has the same structure as that of the region A. In the third column from the left and the following columns, the wiring patterns of the first column and the second column are repeated.

In the present embodiment, the photoelectric conversion apparatus that operates with the clock signals CLK1 and CLK2 of the two kinds of phases is described as an example, but the present invention can also be applied to the case of the photoelectric conversion apparatus that is driven by clock signals of three or more kinds of phases.

Further, the present embodiment can also be applied to a photoelectric conversion apparatus that has a line memory configured by a plurality of memory sections that hold signals. A first switch is connected to each of the memory sections of the line memory. A first common signal line is configured to have a predetermined number of the first switches connected thereto. A second switch is a switch for connecting the first common signal line to a second common signal line. A signal read section selectively reads the signals that are held by the respective memory sections of the line memory to the second common signal line via the first switch, the first common signal line and the second switch. The present embodiment can also be applied to the photoelectric conversion apparatus like this by causing the signals to be output synchronously with a plurality of clock signals having different phases.

### Second Embodiment

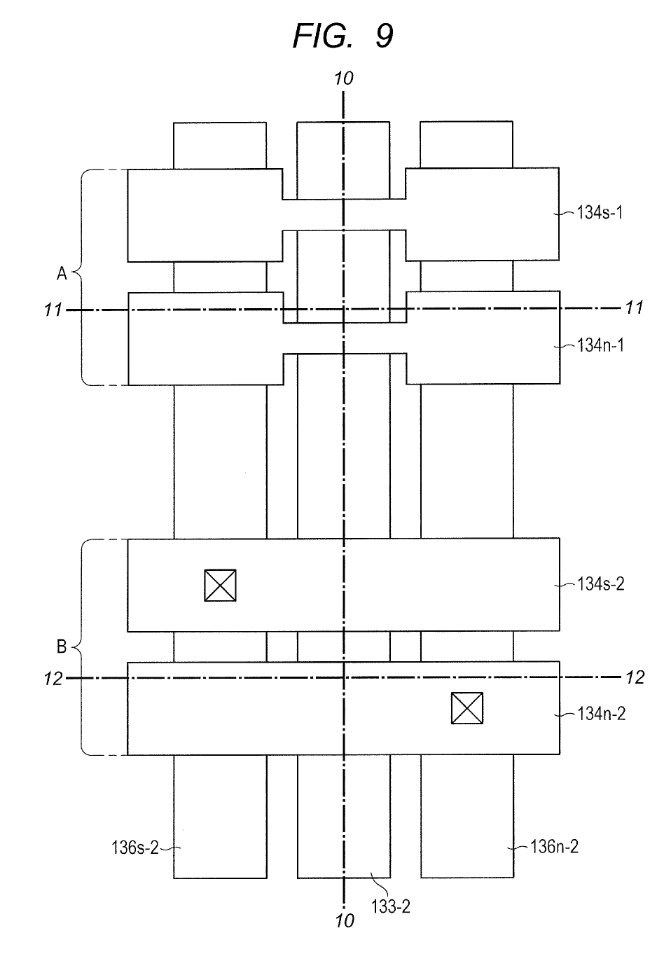

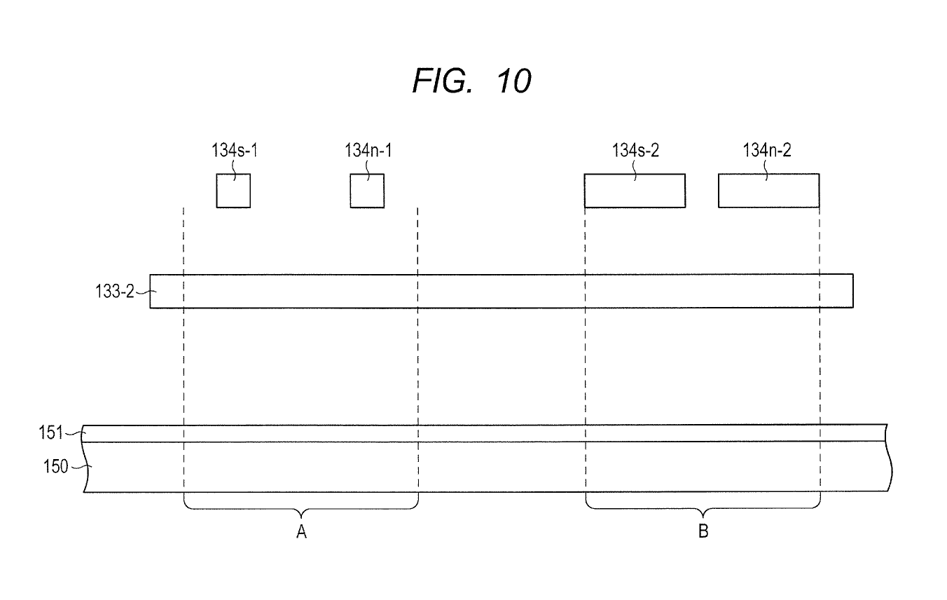

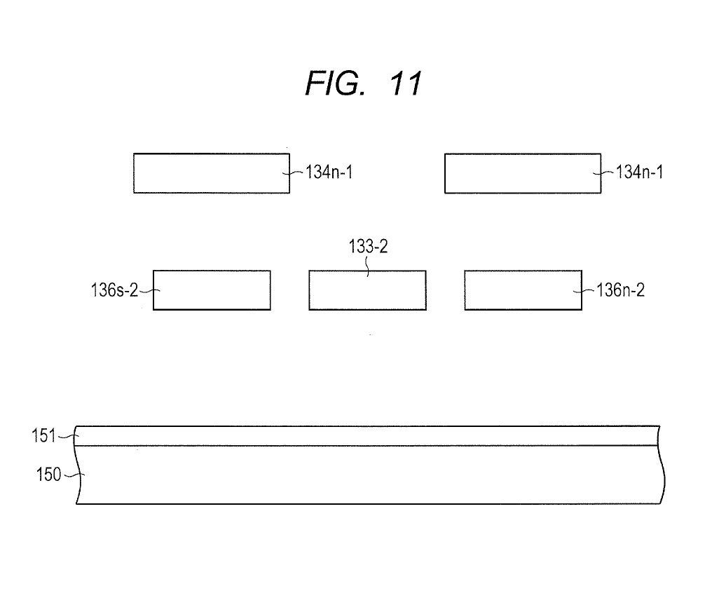

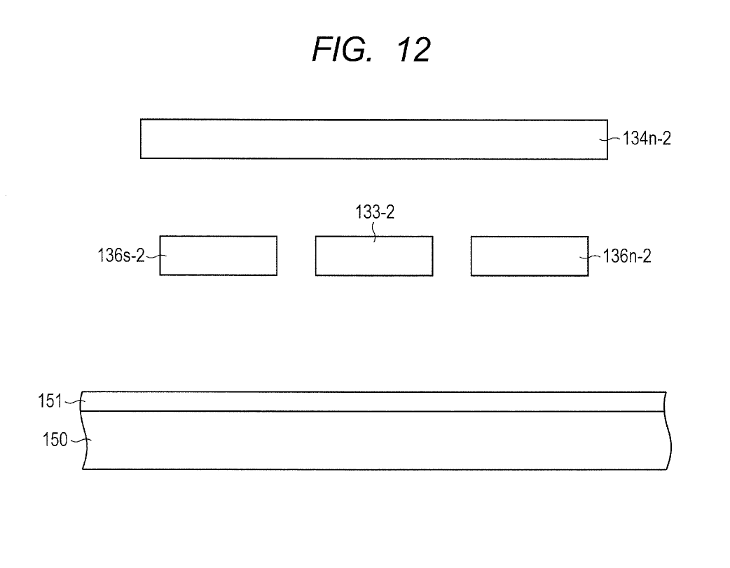

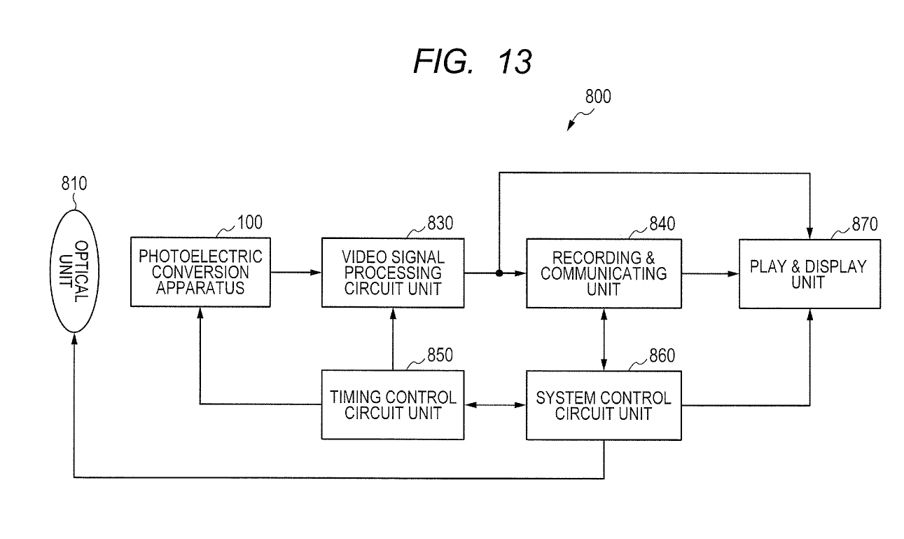

FIG. 9 is a plan view of a photoelectric conversion apparatus according to a second embodiment of the present invention. FIG. 10 is a sectional view taken along the line 10-10 of FIG. 9. FIG. 11 is a sectional view taken along the line 11-11 of FIG. 9. FIG. 12 is a sectional view taken along the line 12-12 of FIG. 9. The present embodiment differs from the first embodiment in a structure of intersection portions of the column selecting line 133-2 and the like and the horizontal output lines 134s-1 and 134n-1. Hereinafter, the point in which the present embodiment differs from the first embodiment will be described.

In the present embodiment, the horizontal output lines 134s-1 and 134n-1 are reduced in capacitive coupling components by having widths thinned in portions which intersect the column selecting line 133-2. Note that in FIG. 9, the horizontal output lines 134s-1 and 134n-1 are thinned, but a width of the column selecting line 133-2 may be thinned in the intersecting portion described above. By adopting a structure in which the widths of the lines differ in the region A and the region B, noise is difficult to superimpose on the horizontal output lines 134s-1 and 134n-1 that are driven in a different phase.

Further, in the present embodiment, both the region A and the region B are formed by using an aluminum wiring with low resistance for the column selecting line 133-2, and therefore, the entire resistance of the column selecting line 133-2 can be reduced.

As above, in the first and the second embodiments, the region A of the portion at which the column selecting line 133-2 intersects the first output lines 134s-1 and 134n-1, and the region B of the portion at which the column selecting line 133-2 intersects the second output lines 134s-2 and 134n-2 have different wiring structure from each other. Note that the column selecting line 133-2 is described as an example, but the same applies to the other column selecting lines 133-1, 133-3 and 133-4.

Since the column selecting line 133-2 and the second output lines 134s-2 and 134n-2 both change in potential synchronously with the clock signal CLK2 of the second phase, the voltages of the second output lines 134s- and 134n-2 are only slightly influenced by the noise accompanying the potential change of the column selecting line 133-2. In contrast with this, the column selecting line 133-2 changes in potential synchronously with the clock signal CLK2 of the second phase, and the first output lines 134s-1 and 134n-1 change in potential synchronously with the clock signal CLK1 of the first phase. Therefore, the voltages of the first output lines 134s-1 and 134n-1 are significantly influenced by the noise accompanying the potential change of the column selecting line 133-2.

Therefore, in the region A of the portion at which the column selecting line 133-2 intersects the first output lines 134s-1 and 134n-1, the wiring structure is made to differ from the wiring structure of the region B of the portion at which the column selecting line 133-2 intersects the second output lines 134s-2 and 134n-2 so that the capacitive coupling is reduced. Thereby, the noise of the first output lines 134s-1 and 134n-1 can be reduced.

### Third Embodiment

FIG. 13 is a diagram illustrating a configuration example of an imaging system according to a third embodiment of the present invention. An imaging system 800 has, for example, an optical unit 810, a photoelectric conversion apparatus 100, a video signal processing circuit unit 830, a recording & communicating unit 840, a timing control circuit unit 850, a system control circuit unit 860, and a play & display unit 870. The photoelectric conversion apparatus 100 corresponds to the photoelectric conversion apparatuses of the first and second embodiments.

The optical unit 810 that is an optical system such as a lens causes light from an object to form an image on a pixel section 101 of the photoelectric conversion apparatus 100, in which a plurality of pixels are arranged in a two-dimensional shape, and forms an image of the object. The photoelectric conversion apparatus 100 outputs a signal corresponding to the light caused to form an image on the pixel section 101 at timing based on a signal from the timing control circuit unit 850. The signal that is output from the photoelectric conversion apparatus 100 is input into the video signal processing circuit unit 830 that is a video signal processing unit, and the video signal processing circuit unit 830 performs signal processing according to a method set by a program. The signal that is obtained by processing in the video signal processing circuit unit 830 is sent to the recording & communicating unit 840 as an image data. The recording & communicating unit 840 sends the signal for forming an image to the play & display unit 870, and causes the play & display unit 870 to play & display a moving image and a still image. The recording & communicating unit 840 receives the signal from the video signal processing circuit unit 830, and not only performs communication with the system control circuit unit 860 but also performs an operation of recording the signal for forming an image in a recording medium not illustrated.

The system control circuit unit 860 integrally controls an operation of the imaging system, and controls drive of the optical unit 810, the timing control circuit unit 850, the recording & communicating unit 840 and the play & display unit 870. Further, the system control circuit unit 860 includes a storage apparatus not illustrated that is a recording medium, for example, and a program that is necessary to control the operation of the imaging system is recorded therein. Further, the system control circuit unit 860 supplies a signal for switching the drive mode according to the operation of a user, for example, into the imaging system. Specific examples include change of the row to be read and the row to be reset, change of the angle of view accompanying electronic zoom, and shift of the angle of view accompanying electronic vibration isolation. The timing control circuit unit 850 controls drive timing of the photoelectric conversion apparatus 100 and the video signal processing circuit unit 830 based on control by the system control circuit unit 860.

Note that each of the above described exemplary embodiments only illustrates an example of embodiment in carrying out the present invention, and the technical scope of the present invention is not interpreted limitatively by the exemplary embodiments. That is, the present invention can be carried out in various forms without departing from the technical concept of the present invention or the main feature of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-092459, filed Apr. 25, 2013, which is hereby incorporated by reference herein in its entirety.

1. A photoelectric conversion apparatus comprising:
a plurality of pixels arranged in rows and columns, and each configured to generate a signal by photoelectric conversion;
a plurality of holding capacitors each arranged correspondingly to one of the columns of the plurality of pixels, and configured to hold a signal based on the signal generated by the pixel;
a first output line;
a second output line;
a first switch arranged between the holding capacitor and the first output line;
a second switch arranged between the holding capacitor and the second output line; and
a column selecting line configured to control the second switch, wherein
a wiring structure of a portion at which the column selecting line intersects with the first output line is different from a wiring structure of a portion at which the column selecting line intersects with the second output line.

2. The photoelectric conversion apparatus according to claim 1, wherein the portion of at which the column selecting line intersects the first output line, and the portion at which the column selecting line intersects the second output line are formed in mutually different wiring layers.

3. The photoelectric conversion apparatus according to claim 1, wherein a shielding is arranged between the column selecting line and the first output line at the portion at which the column selecting line intersects with the first output line, and
no shielding is arranged between the column selecting line and the second output line at the portion at which the column selecting line intersects with the second output line.

4. The photoelectric conversion apparatus according to claim 1, wherein the portion at which the column selecting line intersects with the first output line has a wiring width different from a wiring width of the portion at which the column selecting line intersects with the second output line.

5. The photoelectric conversion apparatus according to claim 1, wherein the plurality of holding capacitors include a first holding capacitor configured to hold a signal of a reset state of the pixel, and a second holding capacitor configured to hold a signal of a non-reset state of the pixel.

6. The photoelectric conversion apparatus according to claim 5, further comprising a differential processing circuit configured to perform a differential processing between the signal outputted from first holding capacitor to the first or second output line and the signal outputted from second holding capacitor to the first or second output line.

7. The photoelectric conversion apparatus according to claim 1, further comprising a controlling unit configured to control the first and second switches, respectively synchronously with signals of mutually different phases.

8. The photoelectric conversion apparatus according to claim 1, wherein the wiring structure of the portion at which the column selecting line intersects with the first output line is formed poly-silicon, and the wiring structure of the portion at which the column selecting line intersects with the second output line is formed from aluminum.

9. An imaging system comprising:
the photoelectric conversion apparatus according to claim 1; and
a processing unit configured to process a signal outputted from the photoelectric conversion apparatus.

10. The photoelectric conversion apparatus according to claim 2, wherein a shielding is arranged between the column selecting line and the first output line at the portion at which the column selecting line intersects with the first output line, and
no shielding is arranged between the column selecting line and the second output line at the portion at which the column selecting line intersects with the second output line.

11. The photoelectric conversion apparatus according to claim 2, wherein the portion at which the column selecting line intersects with the first output line has a wiring width different from a wiring width of the portion at which the column selecting line intersects with the second output line.

12. The photoelectric conversion apparatus according to claim 2, wherein the plurality of holding capacitors include a first holding capacitor configured to hold a signal of a reset state of the pixel, and a second holding capacitor configured to hold a signal of a non-reset state of the pixel.

13. The photoelectric conversion apparatus according to claim 12, further comprising a differential processing circuit configured to perform a differential processing between the signal outputted from first holding capacitor to the first or second output line and the signal outputted from second holding capacitor to the first or second output line.

14. The photoelectric conversion apparatus according to claim 2, further comprising a controlling unit configured to control the first and second switches, respectively synchronously with signals of mutually different phases.

15. An imaging system comprising:
the photoelectric conversion apparatus according to claim 2; and
a processing unit configured to process a signal outputted from the photoelectric conversion apparatus.
